(19) United States
(12) Patent Application Publication
(10) Pub. No.: US 2021/0047862 A1
(43) Pub. Date: Feb. 18, 2021

(54) SECURITY SCREENING OF CHECKED LUGGAGE

(71) Applicant: David TROPP, Brooklyn, NY (US)

(72) Inventor: David TROPP, Brooklyn, NY (US)

(21) Appl. No.: 16/939,370

(22) Filed: Jul. 27, 2020

Related U.S. Application Data
(60) Provisional application No. 62/887,124, filed on Aug. 15, 2019.

(51) Int. Cl. E05B 35/10; E05B 37/00; E05B 67/00; G06Q 50/26

(52) U.S. Cl. CPC E05B 35/105; G06Q 50/265; E05B 67/00; E05B 37/0034

(57) ABSTRACT

Method of securing and screening luggage with dual-function locks that the TSA and similar luggage-screening entities can open to screen checked air travelers' luggage.

### REFERENCE TO RELATED APPLICATIONS

This application incorporates by reference and claim the benefit of U.S. Provisional Patent Application 62/887,124 filed Aug. 15, 2019, which incorporates by reference U.S. patent application Ser. No. 16/383,953 filed Apr. 15, 2019 claiming the benefit of U.S. Provisional Application No. 62/779,388 filed Dec. 13, 2018.

### FIELD

This patent specification relates to master keys for locks on air travelers' luggage that is checked at airports and is subject to screening by the Transportation Security Administration (TSA) or similar government-authorized entities in this and other countries, and to such locks and to methods of improving security and efficiency in such luggage screening.

### BACKGROUND

After the events of Sep. 11, 2001 that included the destruction of the World Trade Center, the TSA commenced screening checked luggage. Initially, the U.S. Transportation Security Administration (TSA) recommended leaving checked luggage unlocked. When travelers did not do so, the TSA would cut the locks to gain access for screening and/or used a bundle of existing keys that might open some more common locks. Thereafter, more than a decade ago, two much more efficient systems were introduced. Both are still in use and have been adopted by additional government-authorized luggage screening entities in this and other countries. Both systems rely on master keys and dual-function locks. The screening entity opens and re-locks luggage with master keys that fit a master lock mechanism in each TSA-accepted dual-function lock while a user-operated lock mechanism in the same lock remains locked.

In the first system, the same master key opens the master lock mechanism of all locks identified to a Toch logo showing that the locks are TSA-accepted. This includes locks that differ from each other in the type of their user-operated lock mechanisms, e.g., 3-dial combination lock mechanisms, 4-dial combination lock mechanisms, keyed lock mechanisms, etc. The dual-function locks include padlocks, zipper locks, locks built into luggage, etc. See U.S. Pat. Nos. 7,021,537, 7,036,728, 8,145,576, 9,879,447, 10,641,012, and 10,597,905, all incorporated by reference in this patent specification. The second system uses a different logo to identify TSA-accepted dual-function locks and to applicant's knowledge relies on 7 different master keys for respective different groups of locks. As to any individual one of the different master keys, the second system is like the first system except for the different logo and respective numbers on the keys. The second system can slow the screening process because the screener needs to read a key number from a lock and then look through a bundle of 7 master key to find the key with a matching number. TSA personnel screening checked luggage carry these master keys and use them to open and screen checked luggage. Locks that do not carry one of these logos may be cut to screen luggage contents.

This patent specification is directed to improving systems and method related to locking and screening checked luggage to make them still more efficient and enhance security.

### SUMMARY OF THE DISCLOSURE

According to some embodiments, a method of improving screening air travelers' checked luggage locked with special, dual-function, TSA-accepted locks each having a master lock mechanism and a user-operated lock mechanism comprises: (a) supplying a luggage screening entity with (i) a first master key that opens the master lock mechanism of each lock of only a first group of said TSA-accepted locks, (ii) a second master key that is a higher-security key compared with said first master key and opens the master lock mechanism of each lock of only a second group of said TSA-accepted locks different from the first group, and (iii) a third master key that is different from the first and second master keys and opens the master lock mechanism of each lock of a third group of said TSA-accepted locks that is different from the first and second groups; (b) manufacturing and providing the first, second and third group of locks, wherein: (i) some of the locks of the first group have user-operated lock mechanisms that differ structurally and operationally from those in other locks of the first group, and all locks of the first group have identification structures that identify the locks as TSA-accepted locks, (ii) the locks of the second group have user-operated lock mechanisms that are three-dial combination locks only, and all locks of the second group have said identification structures that identify the locks as TSA-accepted locks, and (iii) the locks of the third group are only locks identified as TSA locks by a structure other than that identifying the locks of the first and second groups; and (c) pursuant to government authorization and a memorandum of understanding between the luggage screening entity and an entity supplying the master keys, using the master keys to open for screening air travelers' checked luggage locked with said locks by unlocking the master lock mechanisms thereof while the user-operated lock mechanisms remain locked.

This method can include one or more of the following additional features: (a) the supplying step can comprise supplying said master keys with the marking Made in U.S.A. thereon; (b) said memorandum of understanding can be with the U.S. Customs and Border Protection agency; (c) the supplying step can include supplying said master keys integrated in a single, hand-fitting handle configured to selectively move each key between a retracted position in which the key is in the handle and an operative position in which the key extends from the handle; (e) the motion of each key can be a sliding motion relative to the handle or the motion of each key can be a pivoting motion relative to the handle; (f) the supplying step can include supplying said first, second, and third master keys held together with additional master keys; (g) the locks of the third group can be identified as TSA-accepted locks by one or more brands of luggage to which said locks are secured; and (h) the step of providing the locks of the third group comprises providing dual-function locks each of which is permanently mounted in or on luggage of a selected brand only.

According to some embodiments, a method of improving screening air travelers' checked luggage locked with special, dual-function, TSA-accepted locks each having a master lock mechanism and a user-operated lock mechanism comprises: (a) supplying a luggage screening entity with (i) a first master key that opens the master lock mechanism of each lock of only a first group of said TSA-accepted locks, (ii) a second master key that differs from the first master key and opens the master lock mechanism of each lock of only a second group of said TSA-accepted locks different from the first group, and (iii) a third master key that differs from the first and second master keys and opens the master lock mechanism of each lock of only a third group of said TSA-accepted locks that is different from the first and second groups; wherein the first and third master keys are higher security keys compared with the second master key; (b) manufacturing and providing the first, second and third group of locks, wherein (i) the locks of the first group are locks with user-operated portions that are lock mechanisms that are build-in lock mechanisms (i.e., intended to be permanently attached to luggage, as for example in FIG. 2) or are keyed lock mechanisms and all locks of the first group have identification structures that identify the locks as TSA-accepted locks, (ii) the locks of the second group comprise locks with user-operated lock mechanisms that are combination locks as well as locks with user-operated lock mechanisms that are keyed locks, and all locks of the second group have said identification structures that identify the locks as TSA-accepted locks, and (iii) the locks of the third group all have said identification structures that identify the locks as TSA-accepted locks; and (c) pursuant to government authorization and a memorandum of understanding between the luggage screening entity and an entity supplying the master keys, using the master keys to open for screening air travelers' checked luggage locked with said locks by unlocking the master lock mechanisms thereof while the user-operated lock mechanisms remain locked.

The method described in the immediately preceding paragraphs can additionally include one or more of the following features: (a) the supplying step can comprise providing said first master key with a blade that has both bitting grooves and a pattern of depressions; (b) the supplying step can comprise providing said third master key with a tubular blade that has a distal end and projections and/or depressions around a circumference of said distal end; (c) the supplying step can comprise supplying said first, second, and third master keys assembled as a three-key holder; and (d) the supplying step comprises supplying said first, second, and third master keys assembled in a key holder together with other master keys.

According to some embodiments, a method of improving screening air travelers' checked luggage locked with special, dual-function, TSA-accepted locks each having a master lock mechanism and a user-operated lock mechanism comprises: (a) supplying a luggage screening entity with (i) a first master key that opens the master lock mechanism of each lock of only a first group of said TSA-accepted locks, (ii) a second master key that differs from the first master key and opens the master lock mechanism of each lock of only a second group of said TSA-accepted locks different from the first group, and (iii) a third master key that differs from the first and second master keys and opens the master lock mechanism of each lock of only a third group of said TSA-accepted locks that is different from the first and second groups; wherein the second master key is a higher security key compared with the first and third master keys; (b) manufacturing and providing the first, second and third group of locks, wherein (i) the locks of the first group include locks with user-operated lock mechanisms that are 3-dial combination locks and locks with user-operated lock mechanisms that are keyed locks, and all the locks of the first group have identification structures that identify the locks as TSA-accepted locks, (ii) the locks of the second group are locks with a master key lock mechanism that opens only with said higher-securing second master key, and all locks of the second group have said identification structures that identify the locks as TSA-accepted locks, and (iii) the locks of the third group and/or luggage to which the locks of the third group all have identification structures that identify the locks as TSA-accepted locks; and (c) pursuant to government authorization and a memorandum of understanding between the luggage screening entity and an entity supplying the master keys, using the master keys to open for screening air travelers' checked luggage locked with said locks by unlocking the master lock mechanisms thereof while the user-operated lock mechanisms remain locked.

The method described in the immediately preceding paragraphs can additionally include one or more of the following features: (a) the identification structure of the locks of the third group can comprise branding of luggage to which the locks of the third group are secured; (b) the supplying step can comprise supplying said master keys with markings indicating that the keys are made in U.S.A.; (c) said memorandum of understanding is with the U.S. Customs and Border Protection; (d) the supplying step can include supplying said master keys integrated in a single, hand-fitting handle configured to selectively move each key between a retracted position in which the key is in the handle and an operative position in which the key extends from the handle; (e) the supplying step can include supplying said first, second, and third master keys held together with additional master keys; and (f) the step of providing the locks of the third group comprises providing dual-function locks each of which is permanently mounted in or on luggage of a selected brand only.

### BRIEF DESCRIPTION OF THE DRAWINGS

FIGS. 1a, 1b, and 2-4 illustrate several different kinds of TSA-accepted dual-function locks that have different types of user-operated lock mechanisms.

FIGS. 5-8b illustrate schematically and in principle several master keys that are believed to be in current use by the TSA and similar entities.

FIGS. 9-15 illustrate high-security master key according to some embodiments.

FIG. 16 illustrates a system of combinations of dual-function locks and master keys according to some embodiments.

FIG. 17 illustrates a system of a key-holder integrating three master keys associated with respective different groups of TSA-accepted locks.

FIG. 18 is an exploded view that illustrates components of the key holder of FIG. 17

FIG. 19 illustrates another system of a key-holder integrating three master keys associated with respective different groups of TSA-accepted locks.

### DETAILED DESCRIPTION

A detailed description of examples of preferred embodiments is provided below. While several embodiments are described, the new subject matter described in this patent specification is not limited to any one embodiment or combination of embodiments described herein, but instead encompasses numerous alternatives, modifications, and equivalents. In addition, while numerous specific details are set forth in the following description in order to provide a thorough understanding, some embodiments can be practiced without some or all these details. Moreover, for the purpose of clarity, certain technical material that is known in the related art has not been described in detail in order to avoid unnecessarily obscuring the new subject matter described herein. Individual features of one or several of the specific embodiments described herein can be used in combination with features of other described embodiments or with other features. Further, like reference numbers and designations in the various drawings indicate like elements.

A dual-function lock that is TSA-accepted and is used in the method and system described in this patent specification has two locking mechanisms. Each opens and locks the lock independently of the other. One is a master lock mechanism and the other is a user-operated (traveler-operated) lock mechanism. There are different types of user-operated lock mechanisms in TSA-accepted locks. One type is a 3-dial combination locks, another is a 4-dial combination locks, yet another is a keyed lock mechanism, and there are additional types that are currently available or are expected to be available. The TSA-accepted luggage locks can be padlocks, built-in locks that are permanently affixed to luggage, zipper locks, and other locks. Such locks are available from sources including http://www.safeskieslocks.com/catalog/, many airport stores, and luggage stores in this country and some other countries.

The TSA and other screening entities have been using master keys manufactured outside the U.S. This patent specification describes a method in which the screening entities are being supplied with master keys made in the U.S. to thereby improve security of operations and ease of replacing damaged keys or supplying additional master keys, enable better assurance that they would only be distributed to authorized recipients, better control quality, and speed up delivery of duplicate keys as needed by luggage screening entities in case of key breakage or expansion of screening that requires additional sets of master keys.

In addition, currently there are increased tariffs on certain foreign-made goods and possible delays or interruption of supplies of such keys from overseas manufacturers. Having the master keys manufactured in this country may benefit in reducing tariffs on some goods or securing exemptions from such tariffs and avoiding supply interruptions or delays.

According to some embodiments, one of the screening entities is the U.S. Customs and Border Protection.

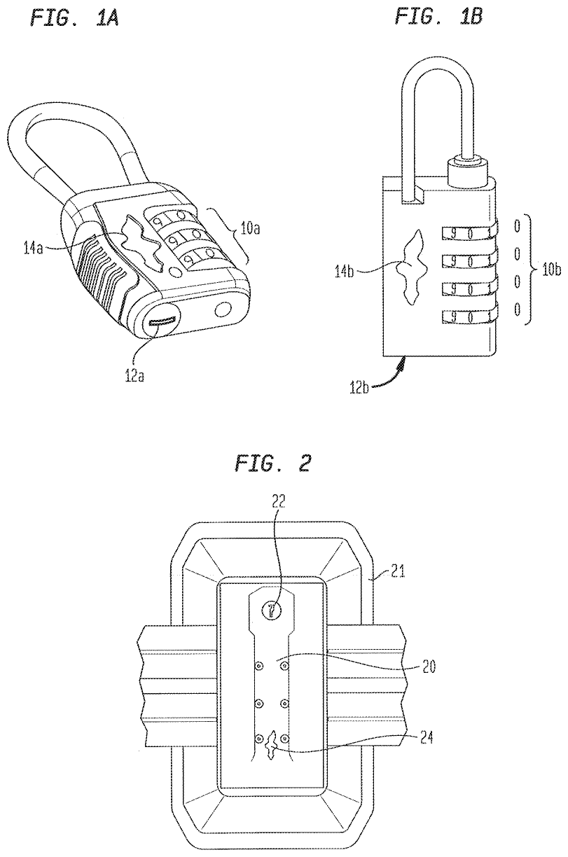

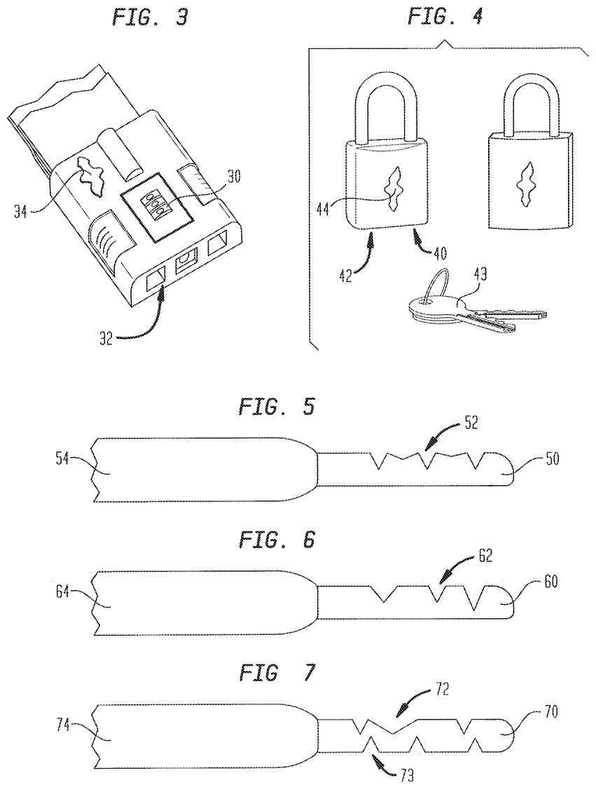

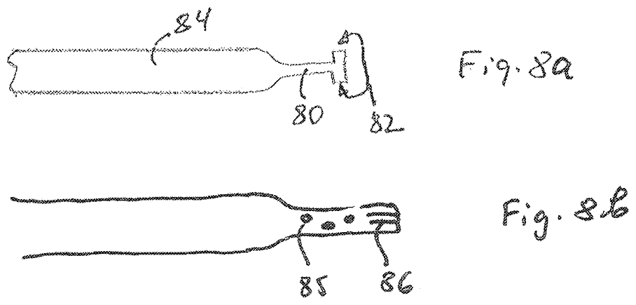

FIGS. 1a, 1b, and 2-4 show several types of TSA-accepted dual-function locks. FIG. 1a shows a TSA-accepted cable lock having a user-operated lock mechanism 10a that is a 3-dial combination lock, a master key lock mechanism 12a with a slot for a master key, and a readily visible Torch logo 14a informing that the lock is a TSA-accepted lock that the TSA and similar authorized entities can open the lock with a master key for luggage screening. FIG. 1b shows a TSA-accepted padlock having another type user-operated lock mechanism—designated 10b—that is a 4-dial combination lock mechanism, a master key lock mechanism 12b with a slot for a master key, and a Torch logo 14b informing that the lock is a TSA-accepted lock. FIG. 2 shows a part of luggage such as a suitcase 21 with a TSA-accepted lock permanently attached thereto, which lock has a 3-dial combination lock as a user-operated lock mechanism and additionally has a master lock mechanism 22 with a slot for a master key and a Torch logo 24. FIG. 3 shows a TSA-accepted luggage strap lock that has a user-operated lock mechanism 30 that also is 3-dial combination lock mechanism and a master lock mechanism 32 with a slot for a master key and a Torch logo 34. FIG. 4 shows a pair of TSA-accepted locks each having yet another type of user-operated lock mechanism—a keyed lock mechanism 40 that opens with user keys 43 controlled by a user—and additionally has a master lock mechanism 42 with a slot for a master key and a Torch logo 44. While only a padlock with a keyed user-operated lock mechanism is shown in FIG. 4, a keyed lock mechanism can be used in permanently mounted locks of the kind shown in FIG. 2 instead of a 3-dial combination lock mechanism, or in zipper locks as in FIG. 3, of in locks built into luggage. Other TSA-approved dual-function locks can have other types of user-operated lock mechanisms such as a finger-print operated mechanism, an electronic lock mechanism controlled wirelessly with a device such a smartphone, etc.

In this patent specification the term “type” is used in to designate TSA-accepted dual function locks with one or more specified kinds of user-operated lock mechanisms—for example, one type of these locks has a user-operated lock mechanism that is a 3-dial combination lock, another type of these locks has a user-operated lock mechanism that is a 4-dial combination lock, yet another type of these locks has a user-operated lock mechanism that is a keyed lock, etc.

In this patent specification, the term “group” of locks is used to designate a plurality of TSA-accepted dual-function locks that share a defined characteristic of their used-operated lock mechanism. For example, one group may be only locks of a single “type,” e.g., only locks with a 3-dial combination lock user-operated lock mechanism. Another group may be locks of two or more of said types of locks. Another group may be locks that open only with a specified high security master key. Yet another group may be only locks that are associated with one or more specified brands of luggage.

Master keys can be in different forms. Master keys in current use by the TSA for screening luggage are believed to comprise a blade with a bitting of cuts into the blade forming projections extending outwardly from the blade and arranged in a linear row, and a bow or handle. FIG. 5 schematically illustrates such a current key that has a blade 50 with bitting 52 in a linear row of projections that extend up from one side of the blade. FIG. 6 illustrates another example where the master key has a blade 60 and a handle 64 formed as a single piece of sheet metal, and similar bitting 62 of projections extending in a row up from blade 60. FIG. 7 illustrates a key otherwise the same as FIG. 6 but having an additional bitting 73 with projections in a linear row extending down from the blade. FIG. 8a shows another example that is otherwise like FIGS. 6 and 7 but has a single projection up and a single projection down from the distal end of blade 80. FIG. 8b illustrates a master key that has a blade with a pattern of depressions 85 and grooves 86 at its distal end extending parallel to a long axis of the blade. FIGS. 5-8a are not to scale and do not show the actual operating portions of master keys in current TSA use.

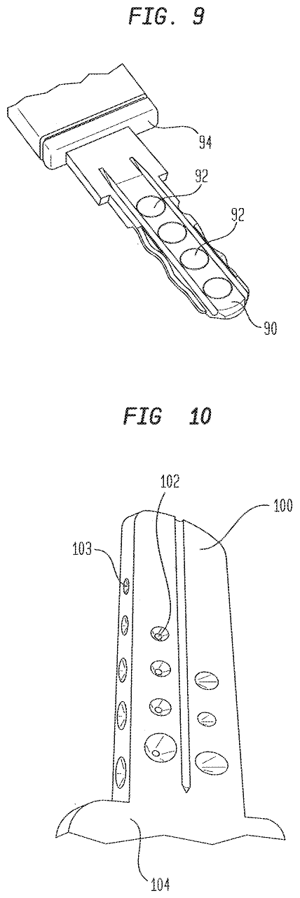

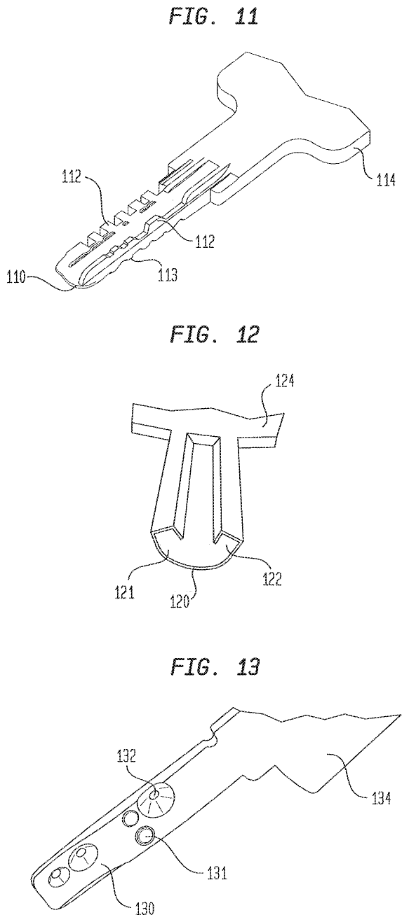

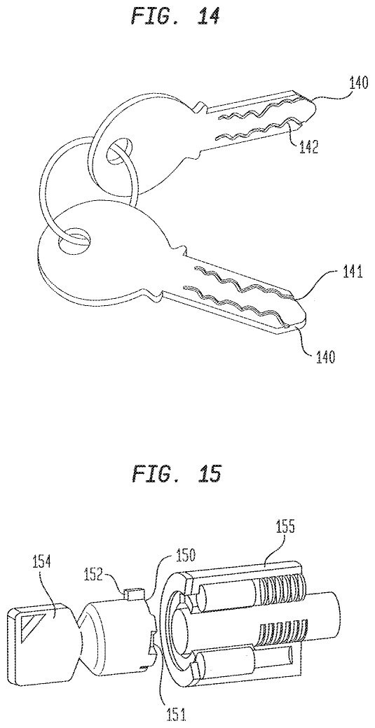

According to some embodiments, a master key can be a lower-security key as in FIGS. 5-7 or a higher-securing key as illustrated in FIGS. 9-15. FIG. 9 illustrates one example of a high-security key that has a blade 90 provided with a plurality of magnetic elements 92 arranged in a selected pattern along the blade and has a bow or handle 94. In other embodiments, the high-security master key can be: (a) as in FIG. 10, with indentations 102 in one pattern on one side of a blade 100 and indentations 103 in another pattern on another, perpendicular side of the blade (and possible indentations on one or both of the remaining sides of the blade) and a bow or handle 104; or (b) as in FIG. 11, with a pattern 112 of indentations and/or projections on one or both sides of one surface of a blade 110 and another pattern 113 on an opposite side of the blade, and a bow or handle 114; or (c) as in FIG. 12, with a blade 120 having two channels 121 and 122 each concealing a respective pattern of projections and/or indentations along the length of the channel; or (d) as in FIG. 13, with a pattern of one or more magnetic elements 131 and one or more indentations and/or projections 132 along a blade 130 and a bow or handle 134; or (e) as in FIG. 14, with channels or grooves such as 141 and 142 meandering in selected patterns along one or more than one surface on a blade 140, and a bow or handle 144; or (f) as in FIG. 15, which illustrates a tubular high-security master key having a bow or handle 154 and an open distal end 150 with a circumference in which more than two indentations and/or projections are formed to engage tumblers in a master lock mechanism such as shown schematically at 155.

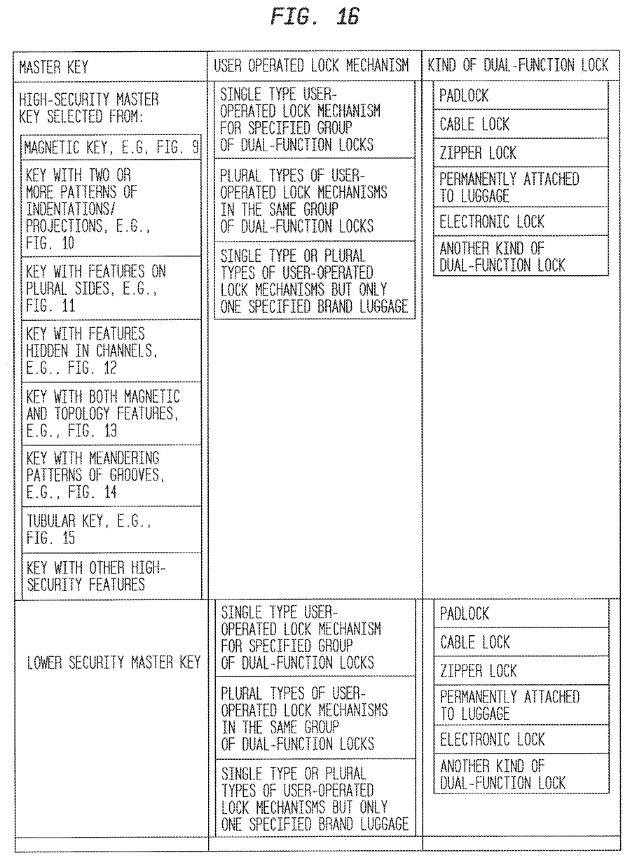

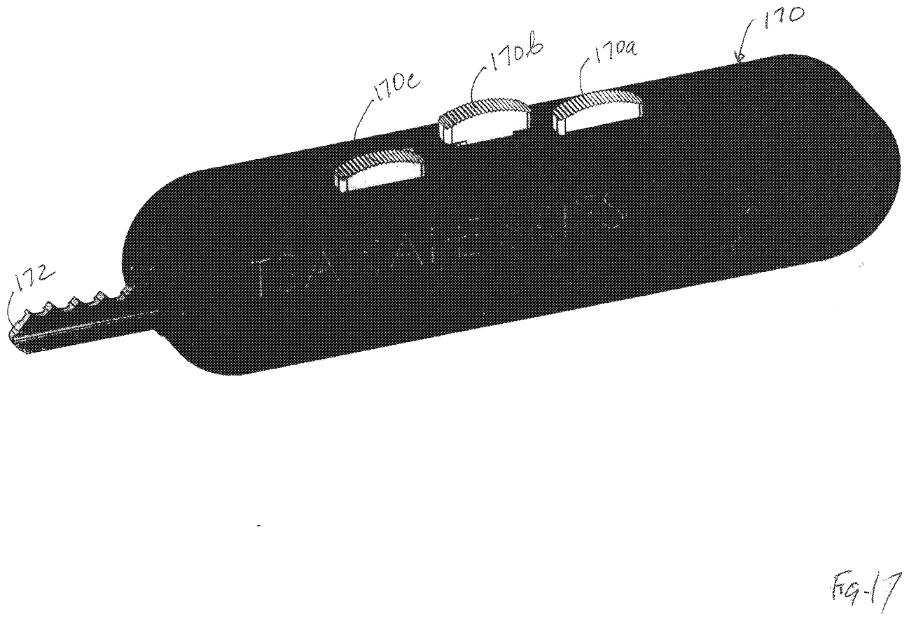

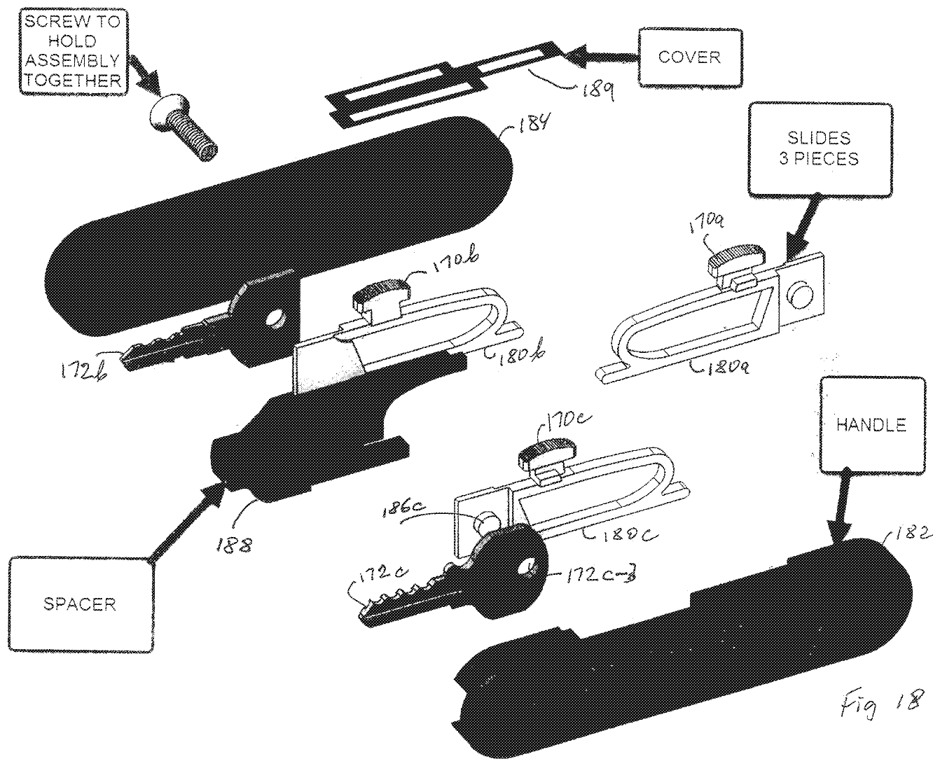

As illustrated in the table of FIG. 16, the master keys in the improved system and method can use high-security keys, for example as in FIGS. 9-15, or other, lower-security keys, such as in FIGS. 5-8. The dual-function locks can include a master lock mechanism that open with a high-security master key or with other master keys. The user-operation mechanisms of portions of a specified group of locks can be the same for all locks in the group, e.g., each lock in the group has a 3-dial combination lock mechanism serving as its user-operating lock mechanism. Or, a specified group of locks can include locks with user-operated lock mechanisms that differ in type—e.g., some are combination lock mechanisms as in FIG. 1a or FIG. 1b or FIG. 2 or FIG. 3 and others are keyed lock mechanisms, for example as in FIG. 4. The locks of one of the groups can be limited to locks for a specified brand of luggage, such as luggage of a widely used brand so that many of the items of luggage that need to be screened will be locked with locks in that group. The locks of a specified group can all be one kind, e.g., only padlocks as in FIGS. 1b and/or 4, or only locks with 3-dial combination locks as in FIGS. 1a, 2 and 4, or only locks permanently attached to luggage as in FIG. 2. In other embodiments, the locks of a specified group can include plural kinds of locks, e.g., both padlocks and locks permanently attached to luggage. Referring to FIG. 16, a master key selected from the high-security keys in the left column can be used with locks having any of the types of user-operated locks in the middle column and any of the kinds of dual-function locks in the right-hand column. Similarly, a lower-security master key can be used with locks having any of the types of user-operated lock mechanisms listed in the middle column, in any of the kinds of dual-function locks lister in the right column.

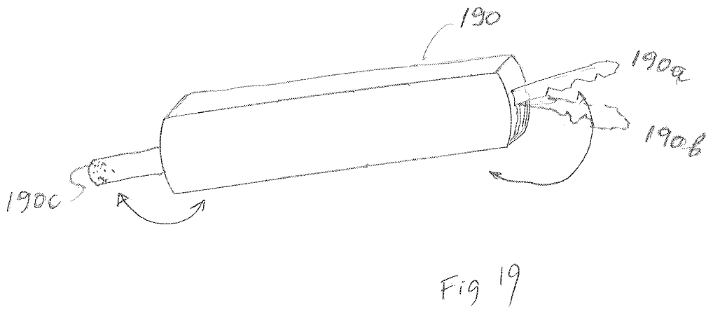

According to some embodiments, the three master keys discussed above can be assembled in a single key holder that helps make luggage screening more convenient and speedier. FIG. 17 illustrates one example in which the three keys are mounted in a single handle 170 with three sliders 170a, 170b, and 170c each sliding along a long axis of the handle to push a respective master key forward and out of the handle, as seen for a master key 172 that can be any of the first, second, and third master keys discussed above. The other two master keys in handle 170 are in retracted positions inside handle 170. FIG. 18 illustrates the internal arrangement, showing handle 170 as two halves 182 and 184 that are held together with screw 186 and contain mechanisms for extending and retracting the master keys. These mechanisms comprise respective slides 180a, 180b, and 180c. The master keys removably attach to the slides by fitting a pin secured to a slide (of which only pin 186 is visible) into a hole in a key (of which only hole 172C-3 is visible). Like pins and holes secure the other two master keys. For clarity, complete sets of sliders and keys are shown for only two keys, with the understanding that there is a like mounted third key. A spacer 188 is attached to the middle slide 180b to guide the sliding motion of the other two slides. A cover 189 fits at one side of the handle and has three slots through which respective sliders 170, 180b, and 170c protrude.

The handle 170 is particularly advantageous because it allows a one-hand operation of selecting a master key to extend into the operating position shown in FIG. 17.

In some embodiments, the three master keys can be held together in a handle that extends a selected key into an operating position by pivoting it as illustrated in FIG. 19. In this example, a handle 190 is elongated to fit a hand and has two keys 190a and 190b at one end and a third key 190c at an opposite end. The three keys are mounted as the blades of a “Swiss Army Knife” or a common multi-tool to be flipped from a retracted to an extended position as needed. One advantage in this example is that two keys can be in their operating positions at the same time.

In some embodiments, the three master keys discussed above can be assembled in a common key holder together with other master keys that open legacy TSA-accepted dual-function locks, for example with master keys illustrate in one or more of FIGS. 5-8b, or a high-security key such as illustrated in FIG. 15 can be added to a bundle of keys such as the some or all of the 7 master keys in current use discussed above.

The improved system and methods are in some ways counterintuitive rather than a logical extension of the known current luggage screening by the TSA and similar entities. For example, locks for high-security master key contradicts known ideas that locks and master keys need to be inexpensive; a master key limited to locks on luggage of a specified brand contradicts known ideas that a master key should open any brand luggage; and a master key that only opens locks with a single type of a user-operated lock, for example a 3-dial combination lock, may contradict known ideas that at least some master keys should open plural types of locks. Additional unexpected benefits of the new system and method will be apparent to persons skilled in screening checked luggage and persons skilled in manufacturing locks and master keys and in supplying master keys and TSA-accepted dual-function locks.

Although the foregoing has been described in some detail for purposes of clarity, it will be apparent that certain changes and modifications may be made without departing from the principles thereof. There can be many alternative ways of implementing both the processes and apparatuses described herein. Accordingly, the present embodiments are to be considered as illustrative and not restrictive, and the body of work described herein is not to be limited to the details given herein, which may be modified within the scope and equivalents of the appended claims.

1. A method of improving screening air travelers' checked luggage locked with special, dual-function, TSA-accepted locks each having a master lock mechanism and a user-operated lock mechanism, said method comprising:
supplying a luggage screening entity with:
a first master key that opens the master lock mechanism of each lock of only a first group of said TSA-accepted locks;
a second master key that is a higher-security key compared with said first master key and opens the master lock mechanism of each lock of only a second group of said TSA-accepted locks different from the first group; and
a third master key that is different from the first and second master keys and opens the master lock mechanism of each lock of a third group of said TSA-accepted locks that is different from the first and second groups;
manufacturing and providing the first, second and third group of locks, wherein:
some of the locks of the first group have user-operated lock mechanisms that differ structurally and operationally from those in other locks of the first group, and all locks of the first group have identification structures that identify the locks as TSA-accepted locks;
the locks of the second group have user-operated lock mechanisms that are three-dial combination locks only, and all locks of the second group have said identification structures that identify the locks as TSA-accepted locks; and
the locks of the third group are only locks identified as TSA locks by a structure other than that identifying the locks of the first and second groups; and
pursuant to government authorization and a memorandum of understanding between the luggage screening entity and an entity supplying the master keys, using the master keys to open for screening air travelers' checked luggage locked with said locks by unlocking the master lock mechanisms thereof while the user-operated lock mechanisms remain locked.

2. The method of claim 1, in which the supplying step comprises supplying said master keys with the marking Made in U.S.A. thereon or otherwise indicating that the keys are manufactured in the U.S.A.

3. The method of claim 1, in which said memorandum of understanding is with the U.S. Customs and Border Protection.

4. The method of claim 1, in which the supplying step includes supplying said master keys integrated in a single, hand-fitting handle configured to selectively move each key between a retracted position in which the key is in the handle and an operative position in which the key extends from the handle.

5. The method of claim 4, in which the motion of each key is a sliding motion relative to the handle.

6. The method of claim 4, in which the motion of each key is a pivoting motion relative to the handle.

7. The method of claim 1, in which the supplying step includes supplying said first, second, and third master keys held together with additional master keys.

8. The method of claim 1, in which the locks of the third group are identified as TSA-accepted locks by branding luggage to which said locks are secured.

9. The method of claim 1, in which the step of providing the locks of the third group comprises providing dual-function locks each of which is permanently mounted in or on luggage of a selected brand only.

10. A method of improving screening air travelers' checked luggage locked with special, dual-function, TSA-accepted locks each having a master lock mechanism and a user-operated lock mechanism, said method comprising:
supplying a luggage screening entity with:
a first master key that opens the master lock mechanism of each lock of only a first group of said TSA-accepted locks;
a second master key that differs from the first master key and opens the master lock mechanism of each lock of only a second group of said TSA-accepted locks different from the first group; and
a third master key that differs from the first and second master keys and opens the master lock mechanism of each lock of only a third group of said TSA-accepted locks that is different from the first and second groups;
wherein the first and third master keys are higher security keys compared with the second master key;
manufacturing and providing the first, second and third group of locks, wherein:
the locks of the first group are locks have user-operated portions that are lock mechanisms built into luggage or are keyed locks and all locks of the first group have identification structures that identify the locks as TSA-accepted locks;
the locks of the second group comprise locks have user-operated lock mechanisms that are combination locks as well as locks with user-operated lock mechanisms that are keyed locks, and all locks of the second group have said identification structures that identify the locks as TSA-accepted locks; and
the locks of the third group all have said identification structures that identify the locks as TSA-accepted locks; and
pursuant to government authorization and a memorandum of understanding between the luggage screening entity and an entity supplying the master keys, using the master keys to open for screening air travelers' checked luggage locked with said locks by unlocking the master lock mechanisms thereof while the user-operated lock mechanisms remain locked.

11. The method of claim 10, in which the supplying step comprises providing said first master key with a blade that has both bitting projection and a pattern of depressions.

12. The method of claim 11, in which the supplying step comprises providing said third master key with a tubular blade that has a distal end and projections and/or depressions around a circumference of said distal end.

13. The method of claim 10, in which the supplying step comprises providing said third master key with a tubular blade that has a distal end and projections and/or depressions around a circumference of said distal end.

14. The method of claim 10, in which the supplying step comprises supplying said first, second, and third master keys assembled as a three-key holder.

15. The method of claim 10, in which the supplying step comprises supplying said first, second, and third master keys assembled in a key holder together with other master keys.

16. A method of improving screening air travelers' checked luggage locked with special, dual-function, TSA-accepted locks each having a master lock mechanism and a user-operated lock mechanism, said method comprising:
supplying a luggage screening entity with:
a first master key that opens the master lock mechanism of each lock of only a first group of said TSA-accepted locks;
a second master key that differs from the first master key and opens the master lock mechanism of each lock of only a second group of said TSA-accepted locks different from the first group; and
a third master key that differs from the first and second master keys and opens the master lock mechanism of each lock of only a third group of said TSA-accepted locks that is different from the first and second groups;
wherein the second master key is a higher security key compared with the first and third master keys;
manufacturing and providing the first, second and third group of locks, wherein:
the locks of the first group include locks with user-operated lock mechanisms that are 3-dial combination locks and locks with user-operated lock mechanisms that are keyed locks, and all the locks of the first group have identification structures that identify the locks as TSA-accepted locks;
the locks of the second group are locks with a master key lock mechanism that opens only with said higher-securing second master key, and all locks of the second group have said identification structures that identify the locks as TSA-accepted locks; and
the locks of the third group and/or luggage to which the locks of the third group all have identification structures that identify the locks as TSA-accepted locks; and
pursuant to government authorization and a memorandum of understanding between the luggage screening entity and an entity supplying the master keys, using the master keys to open for screening air travelers' checked luggage locked with said locks by unlocking the master lock mechanisms thereof while the user-operated lock mechanisms remain locked.

17. The method of claim 16, in which the identification structure of the locks of the third group comprises brands of luggage to which the locks of the third group are secured.

18. The method of claim 16, in which the supplying step comprises supplying said master keys with markings indicating that the keys are made in U.S.A.

19. The method of claim 16, in which said memorandum of understanding is with the U.S. Customs and Border Protection.

20. The method of claim 16, in which the supplying step includes supplying said master keys integrated in a single, hand-fitting handle configured to selectively move each key between a retracted position in which the key is in the handle and an operative position in which the key extends from the handle.

21. The method of claim 16, in which the supplying step includes supplying said first, second, and third master keys held together with additional master keys.

22. The method of claim 16, in which the step of providing the locks of the third group comprises providing dual-function locks each of which is permanently mounted in or on luggage of a selected brand only.
